(19) United States
(12) Patent Application Publication
(10) Pub. No.: US 2015/0282615 A1
(43) Pub. Date: Oct. 8, 2015

(54) STORAGE AND TRANSPORT CART WITH LATCH

(71) Applicant: J&J Snack Foods Corp., Pennsauken, NJ (US)

(72) Inventor: L. Scott AMBRUSTER, Elmer, NJ (US)

(73) Assignee: J&J Snack Foods Corp., Pennsauken, NJ (US)

(21) Appl. No.: 14/681,332

(22) Filed: Apr. 8, 2015

Related U.S. Application Data
(60) Provisional application No. 61/976,892, filed on Apr. 8, 2014.

(51) Int. Cl. A47B 81/00; A47B 57/08; B65G 67/04; A47B 95/02; E05C 3/12; E05B 65/46; A47B 55/00; A47B 96/00

(52) U.S. Cl. CPC A47B 81/00; A47B 55/00; A47B 57/08; A47B 96/00; A47B 95/02; E05C 3/12; E05B 65/46; B65G 67/04

(57) ABSTRACT

A storage and transport cart is described. The cart includes a holding body forming an interior compartment, a door attached to the body and moveable between an open position and a closed position, and a latch for releasably securing the door to the holding body in the closed position. The latch includes a base, a bracing member extending from the base, a first engaging member extending from the base and spaced apart from the bracing member, and a second engaging member extending from the base and spaced apart from first engaging member and the bracing member.

### CROSS-REFERENCE TO RELATED APPLICATION

This application claims priority to U.S. Provisional Application No. 61/976,892, filed Apr. 8, 2014, the entirety of which is incorporated by reference herein.

### FIELD OF THE INVENTION

The present invention relates generally to the field of containers for storing and transporting goods, and more particularly to a multi-function containers and securing mechanisms for multi-function containers.

### BACKGROUND

In the baking industry, distribution of food products, including fresh, refrigerated and/or frozen goods, typically involves shipping products from manufacturing facilities to wholesale or retail facilities. Conventional shipping methods include loading containers filled with the products into vehicles, such as semi-trucks, or cargo containers for planes or ships. During transit, the containers are jostled, oftentimes resulting damage to the containers, the products within, and/or the vehicle or cargo container.

While conventional containers may be useful in some instances, there are still numerous deficiencies and the potential for more useful containers and ways to secure such containers during transport.

### SUMMARY

A storage and transport cart is described herein. The cart includes a holding body forming an interior compartment, a door attached to the body and moveable between an open position and a closed position, and a latch for releasably securing the door to the holding body in the closed position. The latch includes a base, a bracing member extending from the base, a first engaging member extending from the base and spaced apart from the bracing member, and a second engaging member extending from the base and spaced apart from first engaging member and the bracing member.

A method of transporting products is also described herein. The method includes providing a plurality of storage and transport carts and packing the plurality of storage and transport carts in a container of a transport vehicle, wherein outer sides of the carts are fitted against each other. Each of the storage and transport carts can include a holding body having a plurality of walls forming an interior compartment, a door attached to the body and moveable between an open position and a closed position, and a latch attached to the holding body or door and moveable between a latched position and an unlatched position. The latch can include a base, a bracing member extending from the base, a first engaging member extending from the base and spaced apart from the bracing member, and a second engaging member extending from the base and spaced apart from first engaging member and the bracing member.

These and other features, objects and advantages of the present invention will become more apparent to one skilled in the art from the following description and claims when read in light of the accompanying drawings.

### BRIEF DESCRIPTION OF THE DRAWINGS

FIG. 1 is a perspective view of a storage and transport cart described herein.

FIG. 2 is a side view of a storage and transport cart described herein.

FIG. 3 is a perspective view of the other side of the storage and transport cart of FIG. 2.

FIG. 4 is a back view of the other side of the storage and transport cart of FIG. 2.

FIG. 5 is an interior view of a bottom portion of the storage and transport cart of FIG. 2.

FIG. 6 is a bottom perspective view of the storage and transport cart of FIG. 2.

FIG. 7 is a front view of the storage and transport cart of FIG. 2.

FIG. 8 is a front view of a storage and transport cart described herein with the door in an open position.

FIG. 9 is a front view of the storage and transport cart of FIG. 8 with the door in a closed position.

FIG. 9 is a front perspective view of a storage and transport cart described herein.

FIG. 10 is a side perspective view of a front end portion of a storage and transport cart described herein.

FIG. 12 is a side view of a storage and transport cart described herein.

FIG. 13 is a bottom view of a latch described herein.

FIG. 14 is a top view of a latch described herein.

FIG. 15 is a side view of a latch described herein.

FIG. 16 is the other side view of the latch of FIG. 15.

FIG. 17 is a view of a latch described herein in a latched position.

FIG. 18 is a view of the latch of FIG. 17 in an unlatched position.

FIG. 19 is a view of the latch of FIG. 17 in another unlatched position.

FIG. 20 is a front view of an interior compartment of a storage and transport cart described herein.

FIG. 20A is a front view of a support of a storage and transport cart described herein.

FIG. 21 is a side view of a middle portion of a storage and transport cart described herein.

FIG. 22 is a flow chart showing a method of transporting products described herein.

FIGS. 23A-B are top views of containers (C) packed in accordance with a method described herein.

### DETAILED DESCRIPTION

A storage and transport cart and a latch for a storage and transport cart is described herein. As used herein, spatially relative terms, such as “horizontal,” “upper,” “lower,” “front,” and “back,” and the like, are used for ease of description to describe one element or feature's relationship to another element(s) or feature(s) as illustrated in the figures. The spatially relative terms are intended to encompass different orientations of the apparatus in use or operation in addition to the orientation depicted in the figures. The apparatus may be otherwise oriented (rotated 90 degrees or at other orientations) and the spatially relative descriptors used herein may likewise be interpreted accordingly.

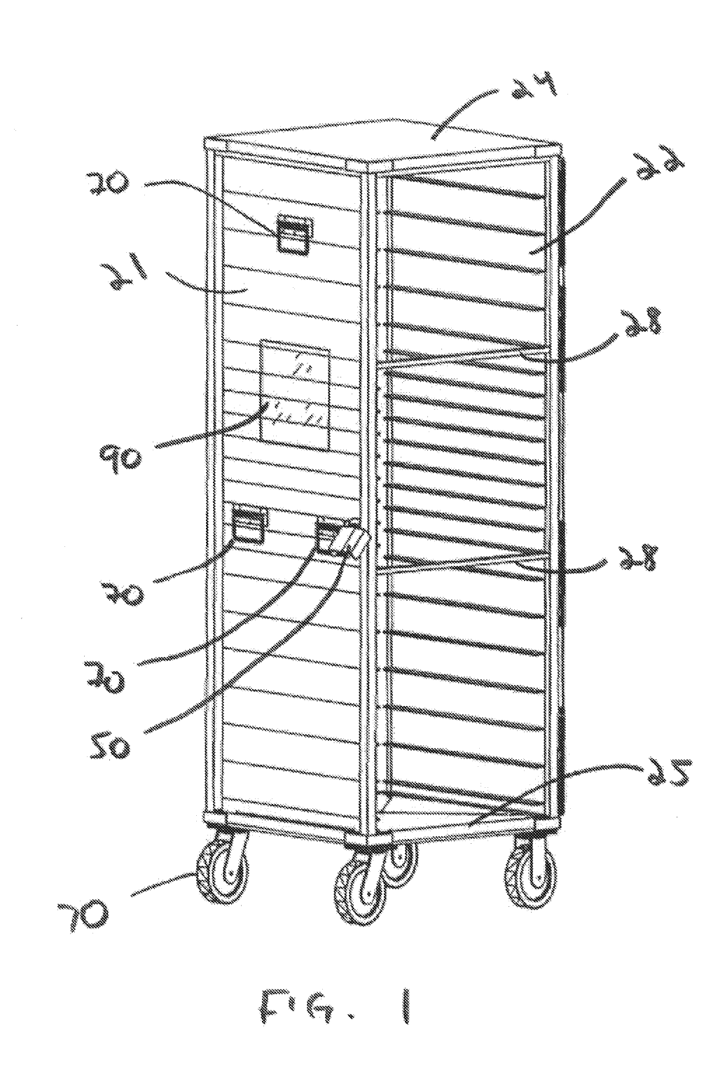

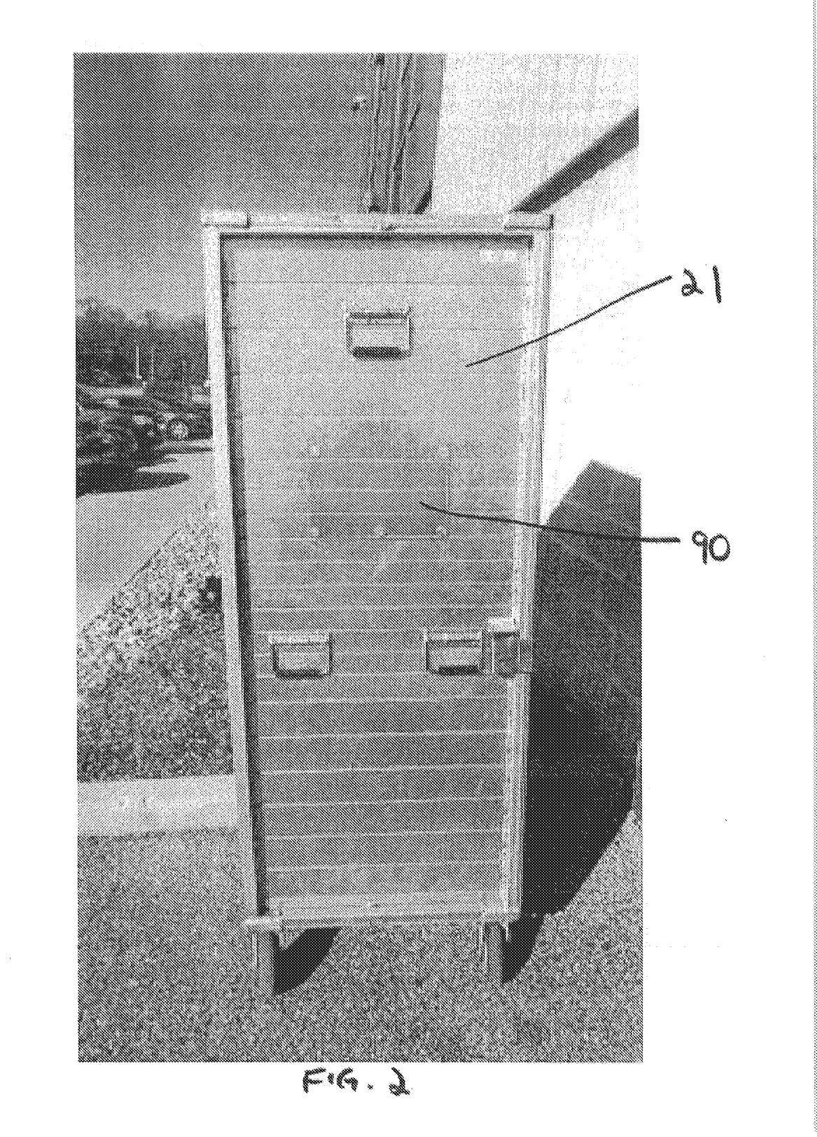

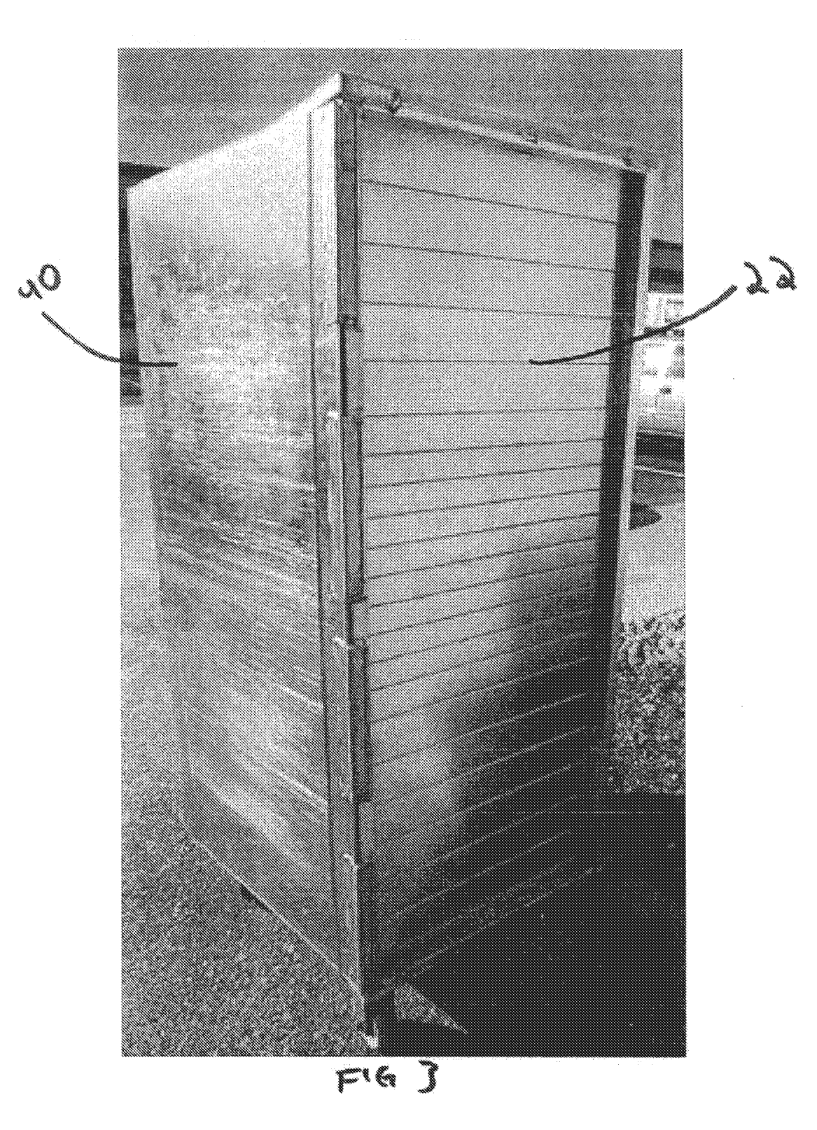

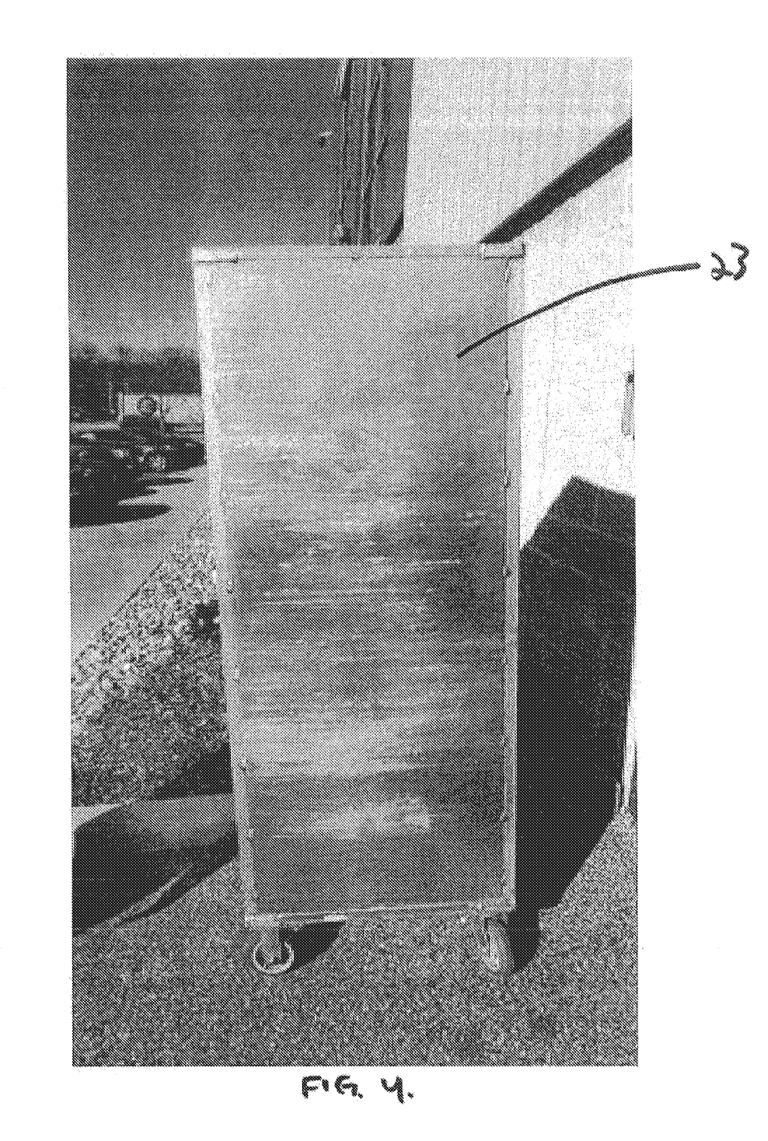

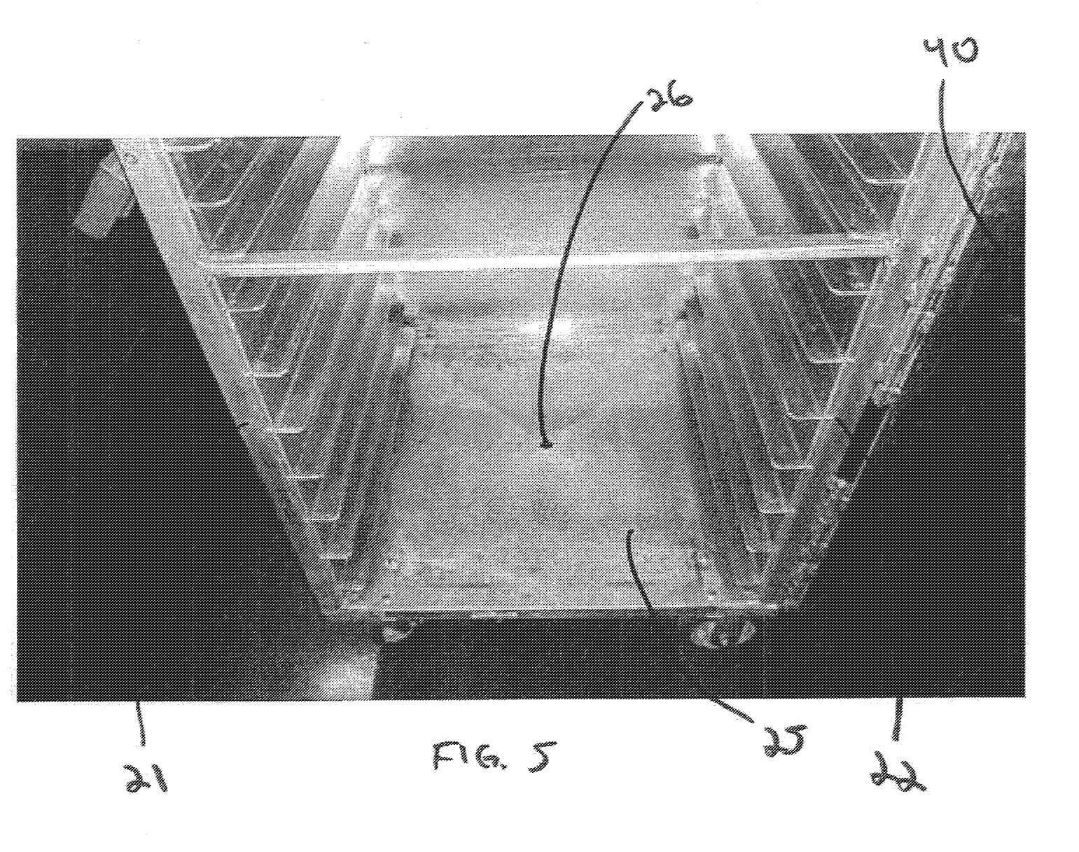

As shown in FIGS. 1-21 the storage and transport cart 10 can include a holding body 15, a door 40 attached to the holding body 15, and a latch 50 attached to the holding body 15 or door 40. The holding body 15 can include a plurality of walls 20 forming an interior compartment 30 for storing products. As shown in FIG. 1 in some embodiments, the plurality of walls 20 can include a first sidewall 21, a second sidewall 22 opposite the first sidewall 21, a back wall 23 extending from a back end of the first sidewall 21 to a back end of the second sidewall 22, a top wall 24, and a bottom wall 25 opposite the top wall 24. FIG. 2 shows the first sidewall 21 in some embodiments. FIG. 3 shows the second sidewall 22 in some embodiments. FIG. 4 shows the back wall 23 in some embodiments.

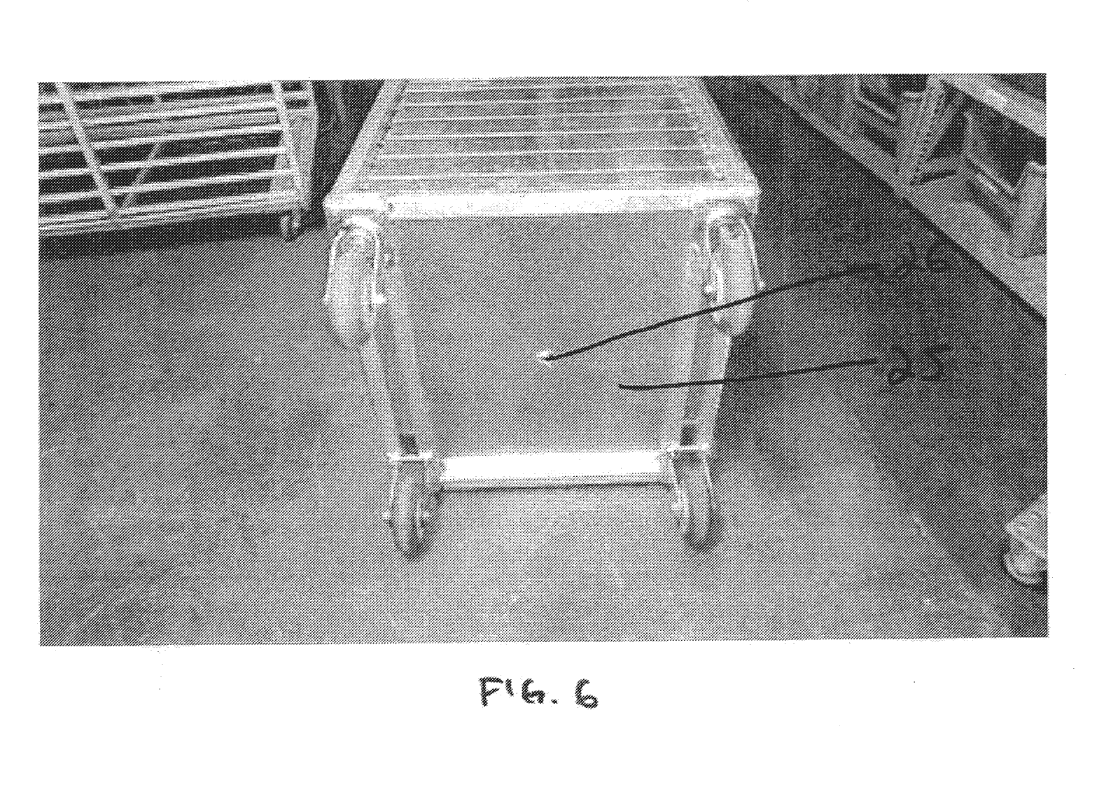

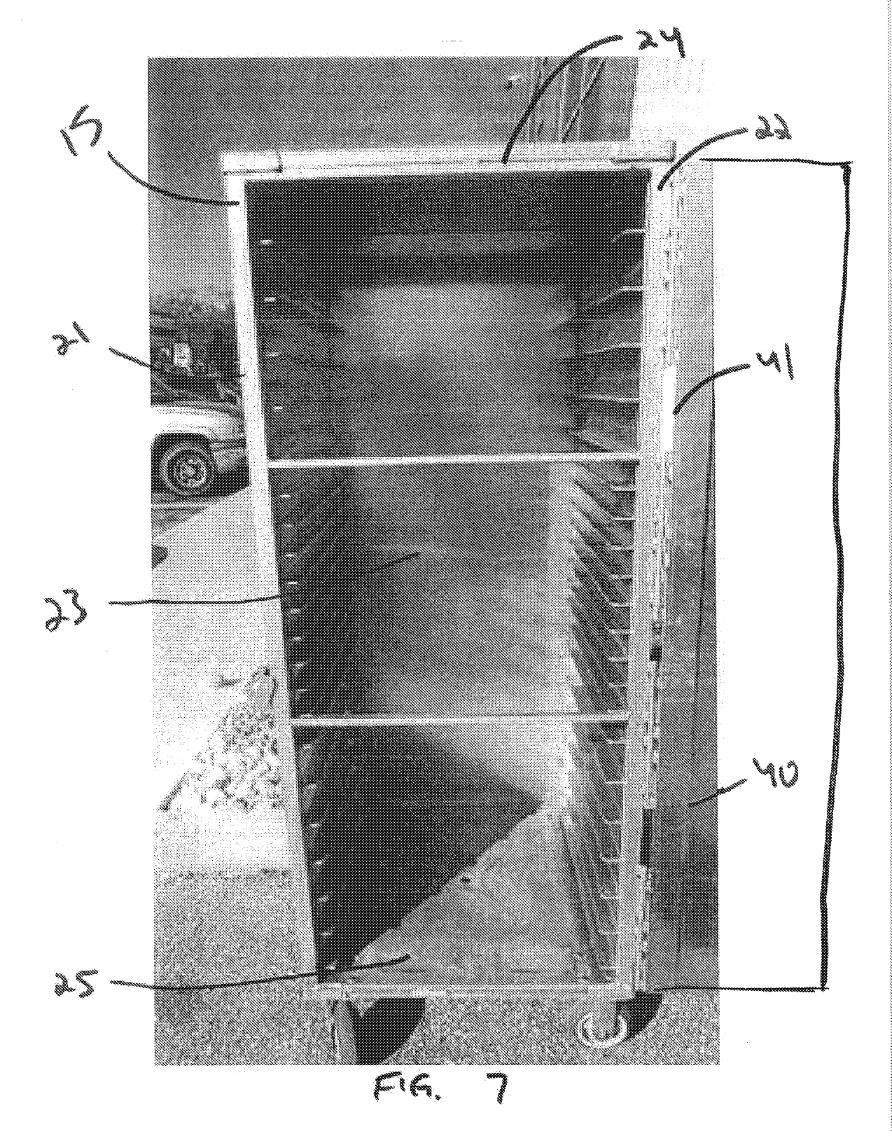

In some embodiments, the bottom wall 25 can include a drain hole 26 extending there through as shown in FIGS. 5 and 6. The drain hole 26 allows a user to easily and efficiently wash the storage and transport cart 10, without the need to tilt the cart 10 at various angles to remove the water or other cleaning agents. In some embodiments, the bottom wall 25 can be pitched toward the drain hole 26. In embodiments with the drain hole 26 in the middle of the bottom wall 25, the bottom wall 25 can be pitched with the lowest elevation in the middle. In some examples, the drain hole 26 can be half an inch wide or other suitable sizes.

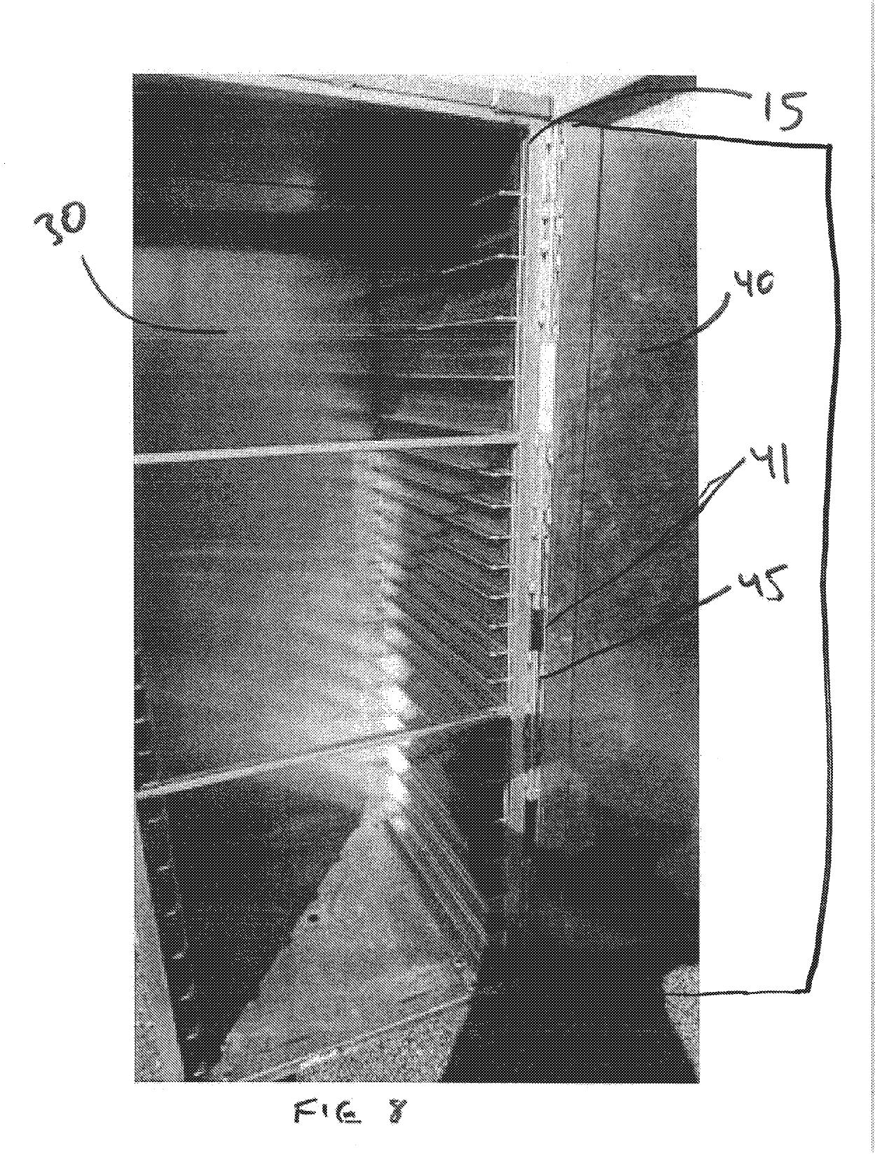

The plurality of walls 20 can leave a portion of the holding body 15 open. For example, a front side of the holding body 15 can be open, as shown in FIG. 7, or only a portion of a side of the holding body 15 can be open. In embodiments with an open front side, the holding body 15 can also include one or more reinforcing bars 28 extending from the first sidewall 21 to the second sidewall 22 proximate a front end of each. For example, the holding body can include at least two spaced apart reinforcing bars 28. In some embodiments, one reinforcing bar 28 can be on an upper half of the front ends and the other reinforcing bar 28 can be on a lower half of the front ends. In one example, the two reinforcing bars 28 can be evenly spaced apart along a height of the open front side, at ⅓ and ⅔ of the distance from the bottom wall 25, as shown in FIG. 1. Other examples can include other suitable spacings.

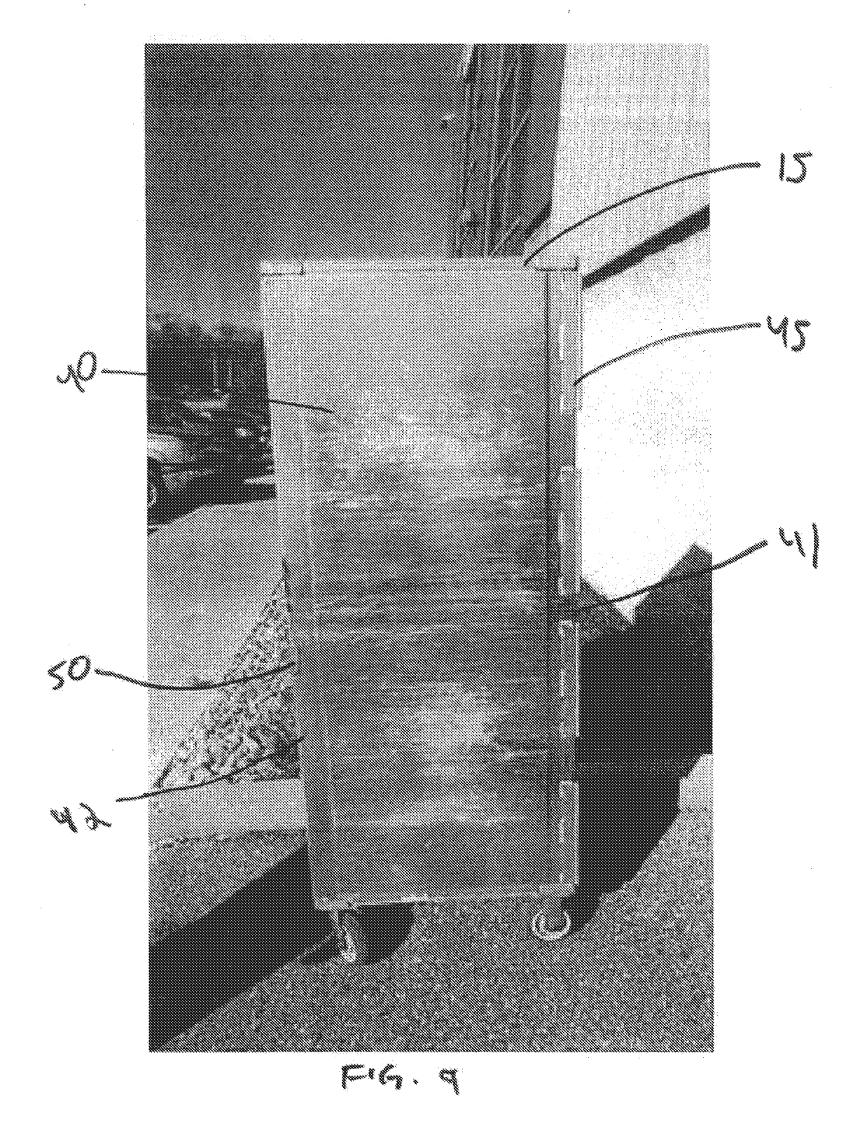

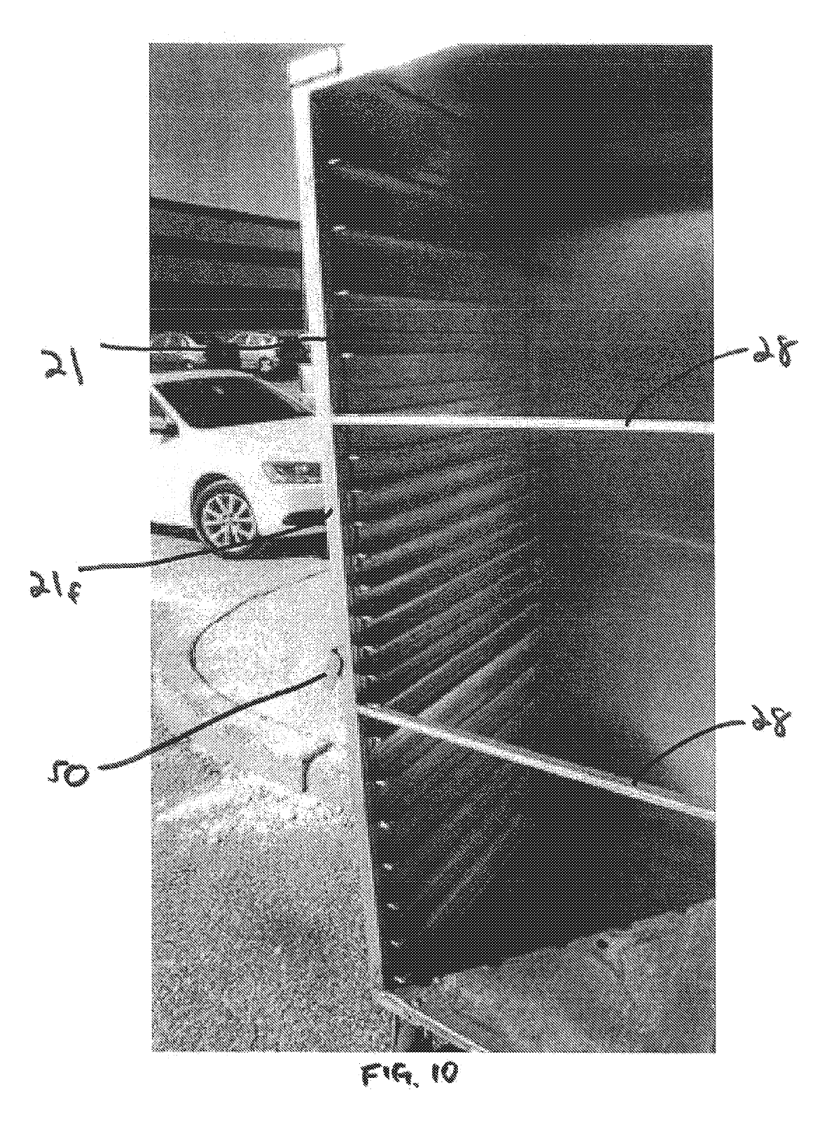

The door 40 for the cart 10 can be attached to the holding body 15 and moveable between an open position providing access to an interior compartment 30 of the holding body 15, for example as shown in FIG. 8, and a closed position enclosing the compartment 30, for example as shown in FIG. 9. In some embodiments, the door 40 can include a fixed end 41 attached to a sidewall, e.g. the second sidewall 22, and allowing the door 40 to swing, slide, or otherwise move between the open and closed positions. In some embodiments, the door 40 can be attached to a sidewall 22 with one or more hinges 45. For example, the hinges can include 3 aluminum 16 inch hinges. In other examples, the hinges can include 4 reinforced aluminum hinges measuring 10 inches. The door 40 can be attached to the holding body 15 with hinges 45 using a sanitary weld. In some embodiments as shown in FIGS. 9-12, in the closed position, a free end 42 of the door 40 can rest against a front end 21f of a sidewall 21 to enclose the compartment 30.

The door 40 can be releasably secured to the holding body 15 in the closed position with latch 50. The latch 50 can be attached to the holding body 15 or to the door 40. In embodiments where the latch 50 is attached to the holding body 15, the latch 50 can be configured to releasably engage with the door 40. In embodiments where the latch 50 is attached to the door 40, the latch 50 can be configured to releasably engage with the holding body 15. The latch 50 can include suitable materials such as aluminum, stainless steel, or other sturdy materials.

The latch 50 can be moveable between a latched position and an unlatched position. In the latched position, the latch 50 is configured to secure the door 40 to the holding body 15 in the closed position. In the unlatched position, the latch 50 is configured to release a portion or an end of the door 40 (e.g. a free end 42) from the holding body 15 to allow an open position. In some embodiments, attachment of the latch 50 to the door 40 or holding body 15 is a pivotal attachment and the latch 50 can rotate between the latched and unlatched positions.

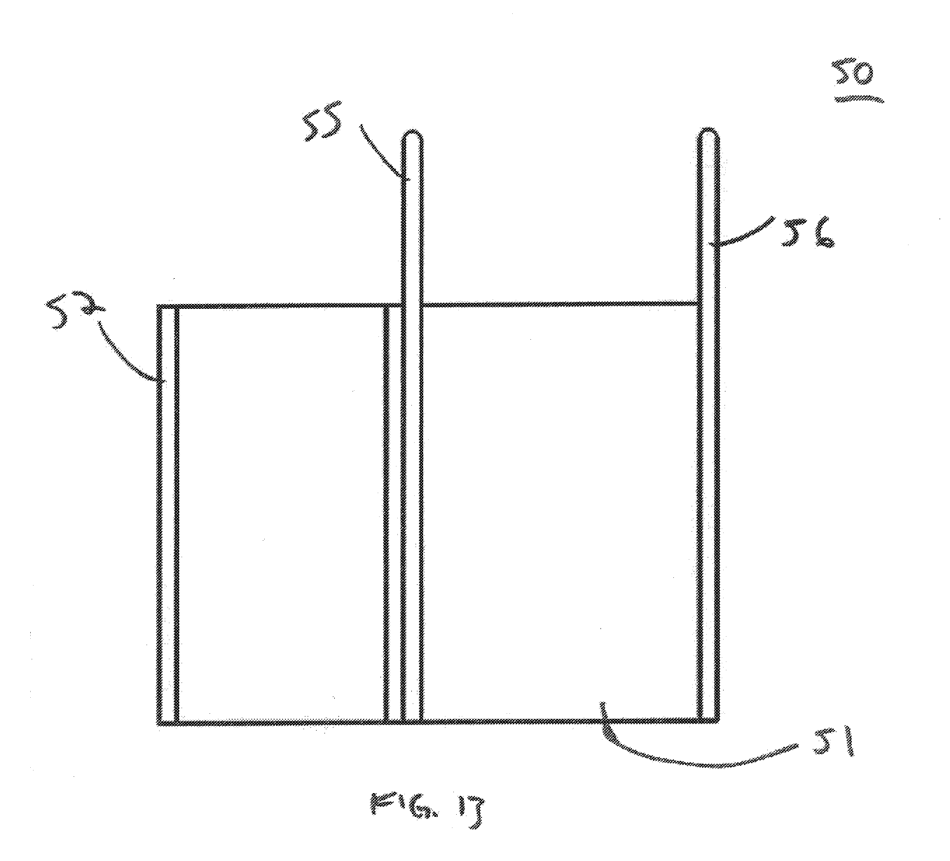

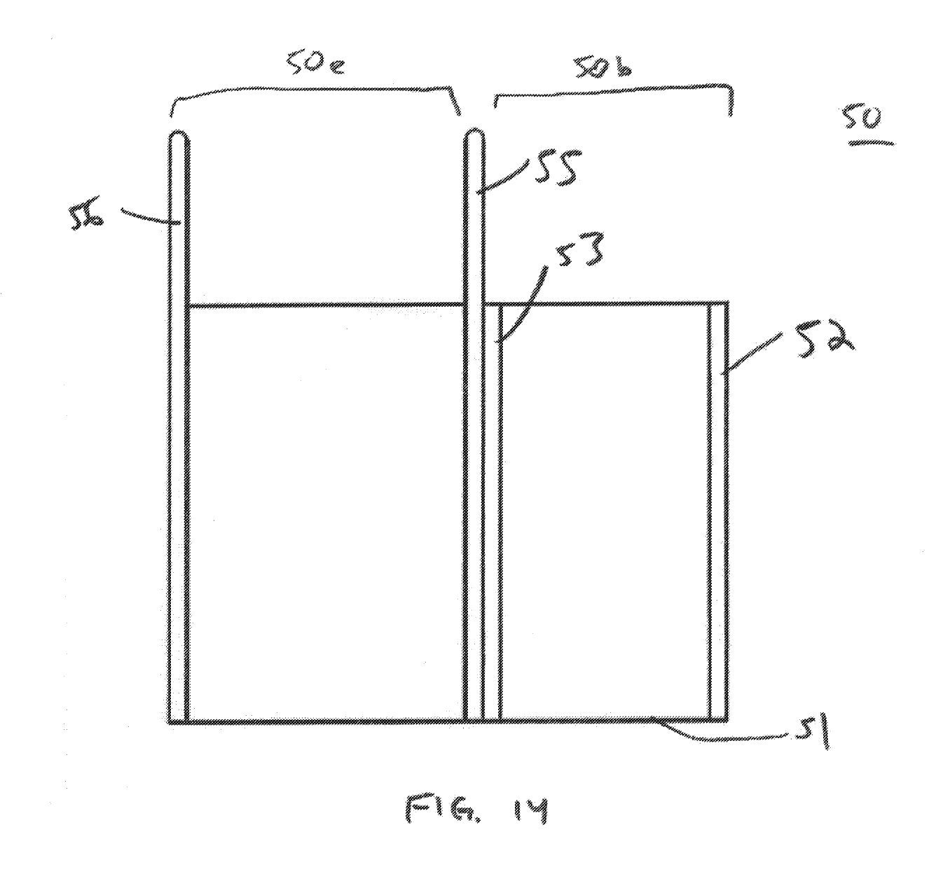

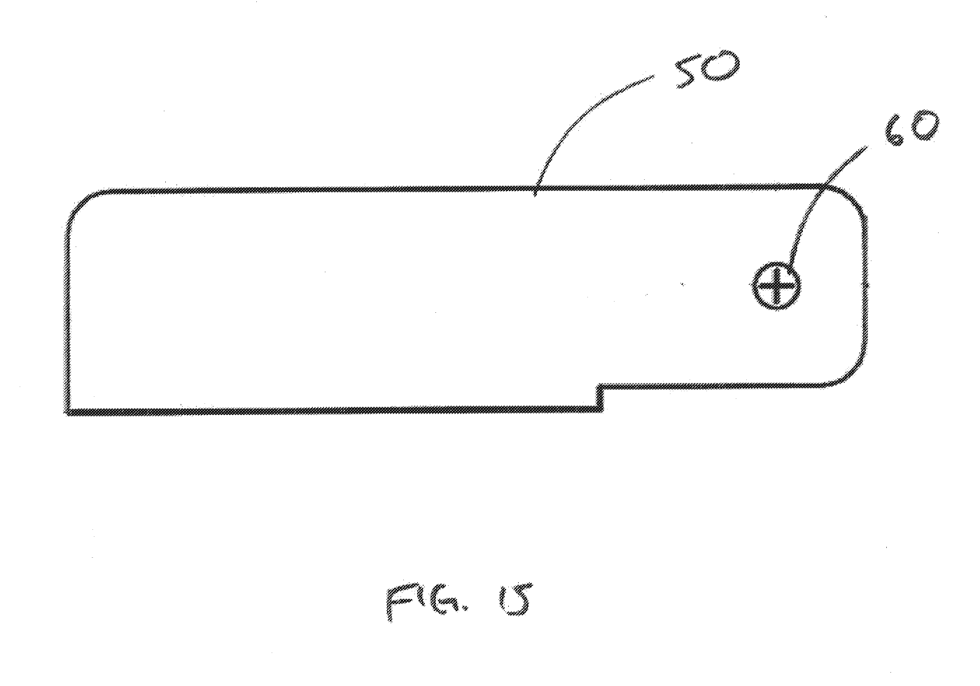

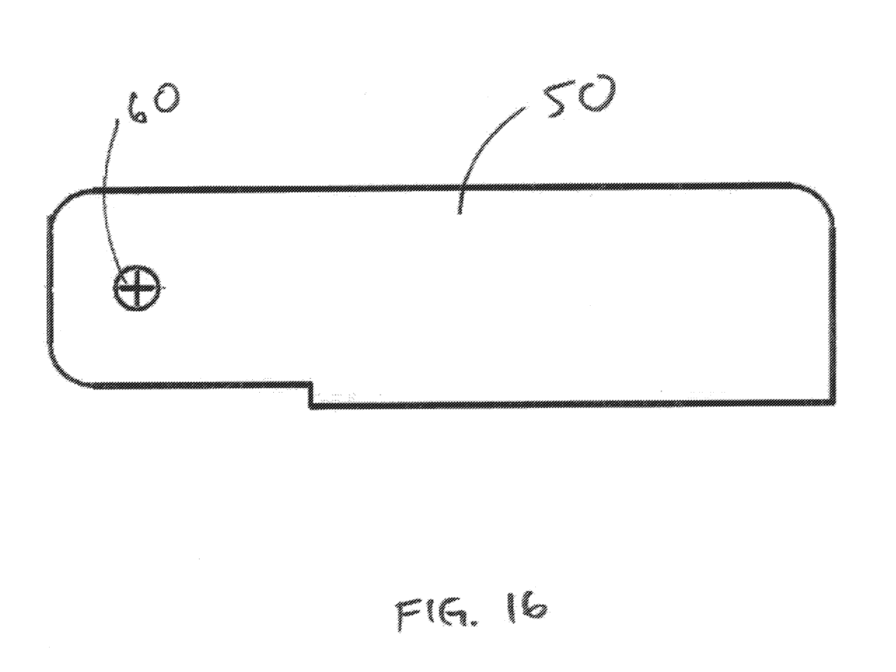

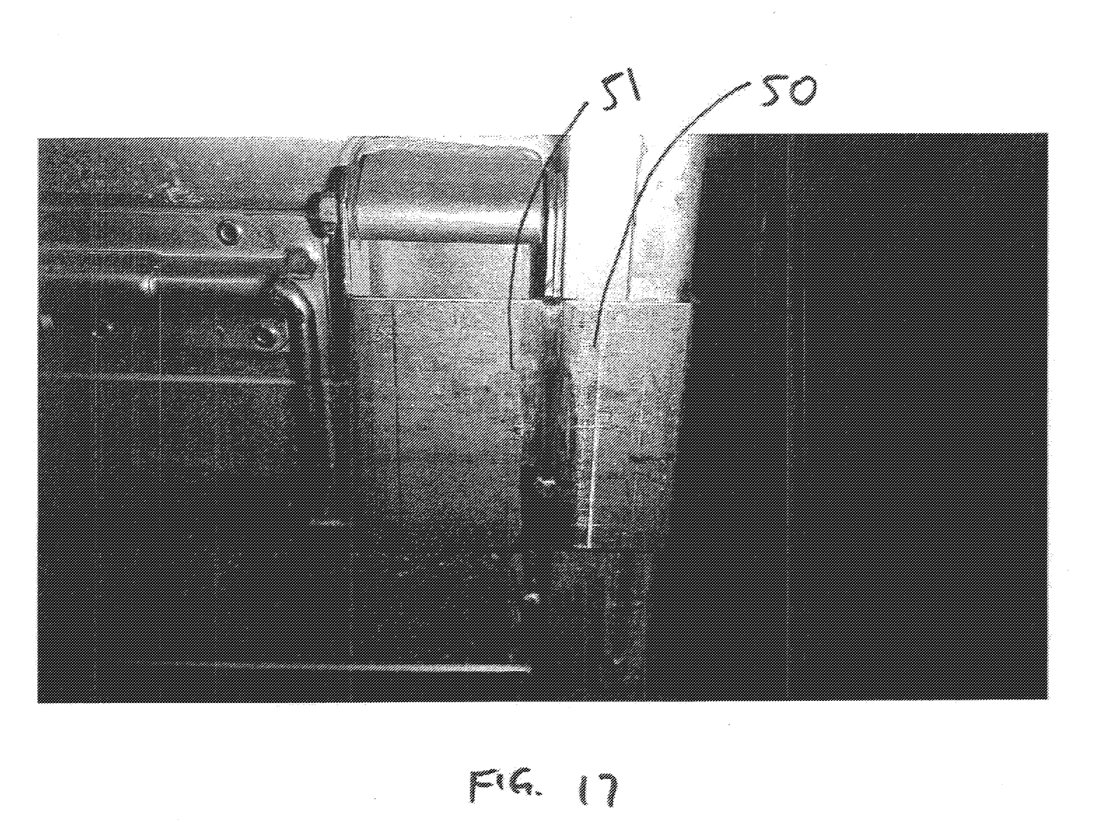

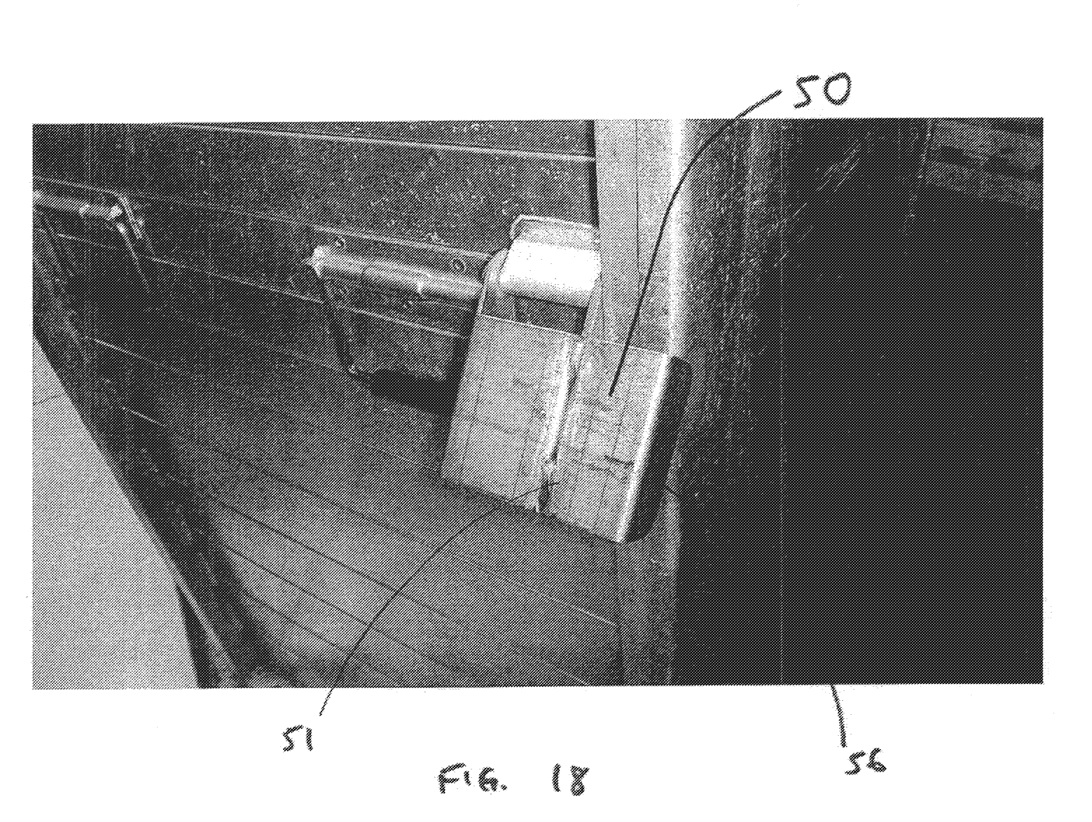

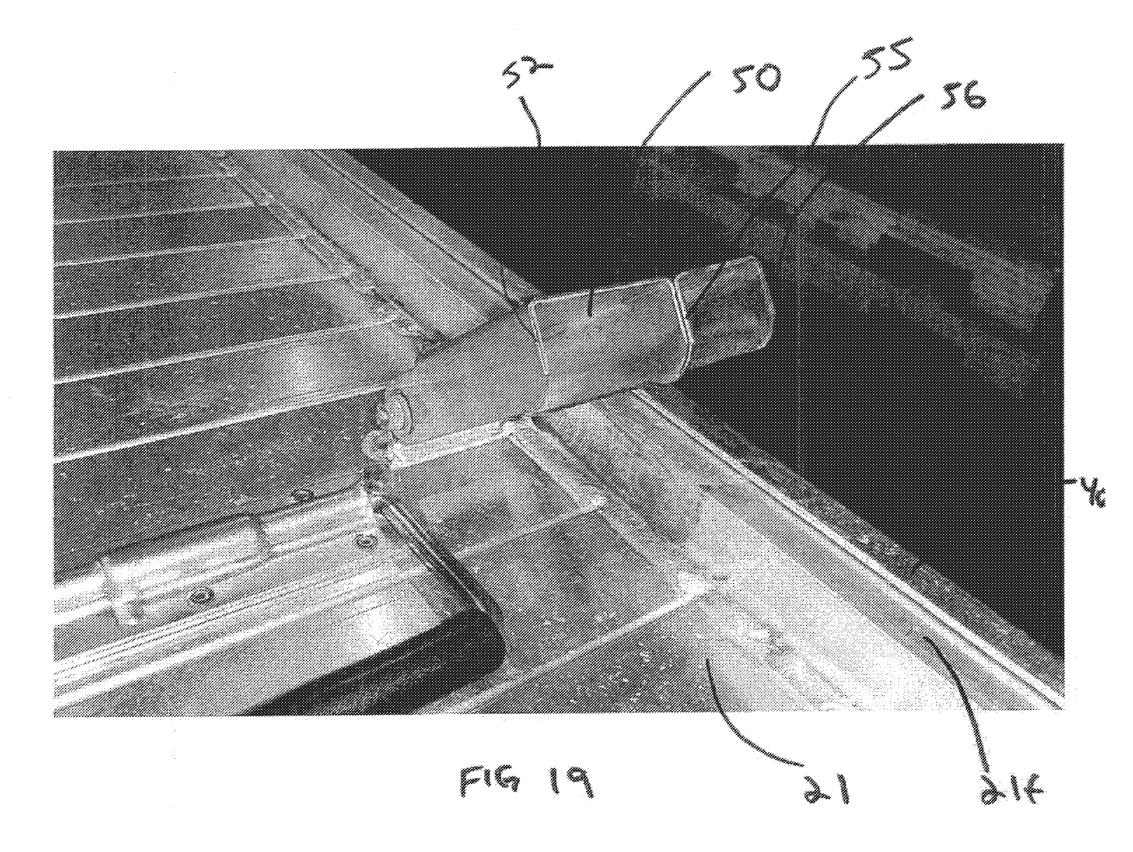

In some embodiments as shown in FIGS. 13 and 14, the latch 50 includes a base 51, a bracing member 52 extending from the base 51, a first engaging member 55 extending from the base 51, and a second engaging member 56 extending from the base 51. The bracing member 52, first engaging member 55, and second engaging member 56 can be spaced apart from each other on the base 51. In some embodiments, the first engaging member 55 can be disposed between the bracing member 52 and the second engaging member 56.

In some embodiments, one or more of the bracing member 52, first engaging member 55, and second engaging member 56 can be substantially perpendicular to the base 51. In some embodiments, the bracing and engaging members 52, 55, 56 can each be substantially perpendicular to the base 51. The bracing and engaging members 52, 55, 56 can also extend from the base 51 in the same direction. In some embodiments, the bracing member 52 can extend from the base 51 at a length less than a length of the second engaging member 56.

In the closed position, the first and second engaging member 55, 56 can releasably clasp the door 40 and/or holding body 15.

In embodiments with a pivotably attached latch 50 as shown in FIGS. 15 and 16, an end of the latch 50 can be fixed to and at least partially rotate about a pivot 60. As shown in FIGS. 17-19, the latch 50 can be rotated downward for the latched position and rotated upward for the unlatched position.

In some embodiments, the latch 50 can be constructed by joining two latch sections. The latch sections can include a bracing section 50b and an engaging section 50e. The bracing section 50b can include a bracing portion of the base 51, a first bracing member 52 extending from the base 51 and a second bracing member 53 extending from the base 51 and spaced apart from the first bracing member 52. The engaging section 50e can include an engaging portion of the base 51, the first engaging member 55 and the second engaging member 56. The bracing section 50b and the engaging section 50e can be joined along the second bracing member 53 and the first engaging member 55 to form a unitary latch 50. An end of the bracing section 50b can be pivotally attached to the holding body 15 or the door 40.

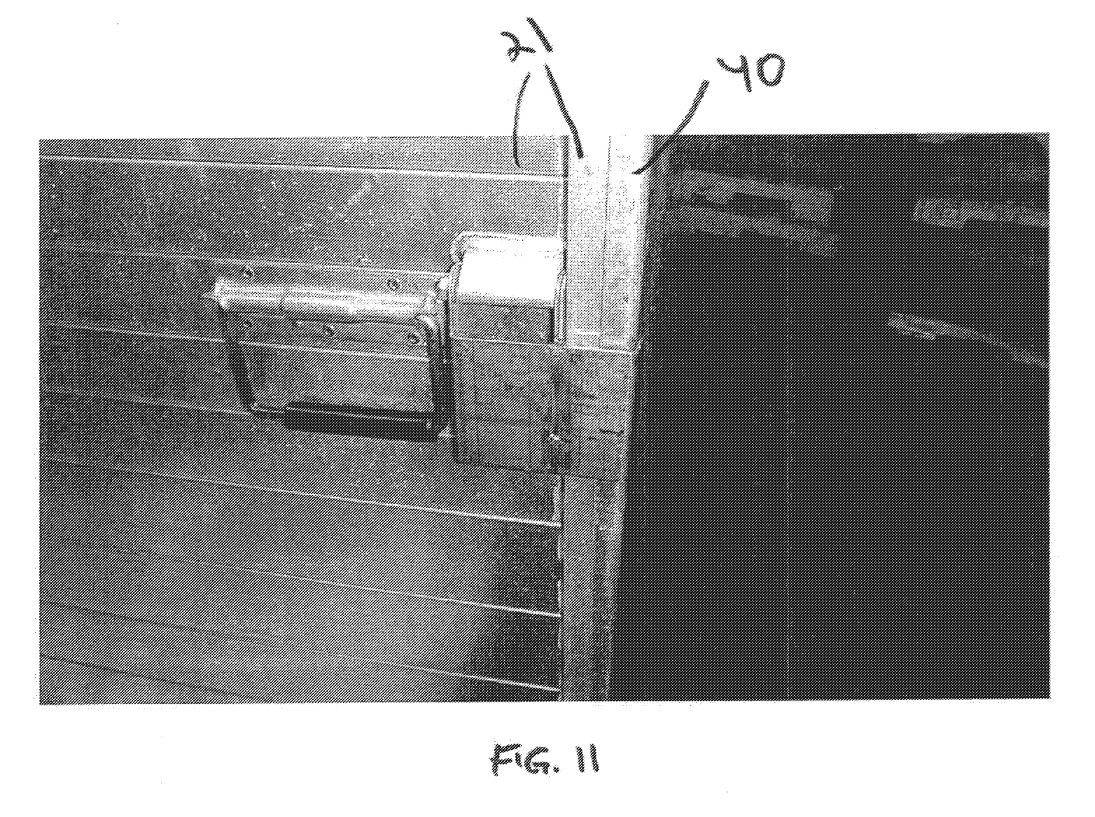

In one embodiment, the latch 50 is attached to one of the sidewalls (e.g. the first sidewall 21) of the holding body 15. The sidewall 21 includes a front edge 21f for receiving the door 40 in the closed position and the latch 50 is pivotably attached to the sidewall 21 proximate the front edge 21f as shown in FIGS. 10-12. The front edge 21f can form a lip 21f as shown in FIG. 19, with the lip 21f extending further outward than the rest of the sidewall 21.

In the latched position, a distal portion of the first engaging member 55 and a distal end of the second engaging member 56 can engage the door 40 to releasably secure the door 40 in the closed position against the lip 21f of the sidewall 21. For example, an inner face of the door 40 can rest against an outer side of the sidewall lip 21f and the first engaging member 55 can engage an inner side of the lip 21f while the second engaging member 56 engages an outer face of the door 40 proximate the free end 42. A distal end of the bracing member 52 can also rest against the sidewall 21.

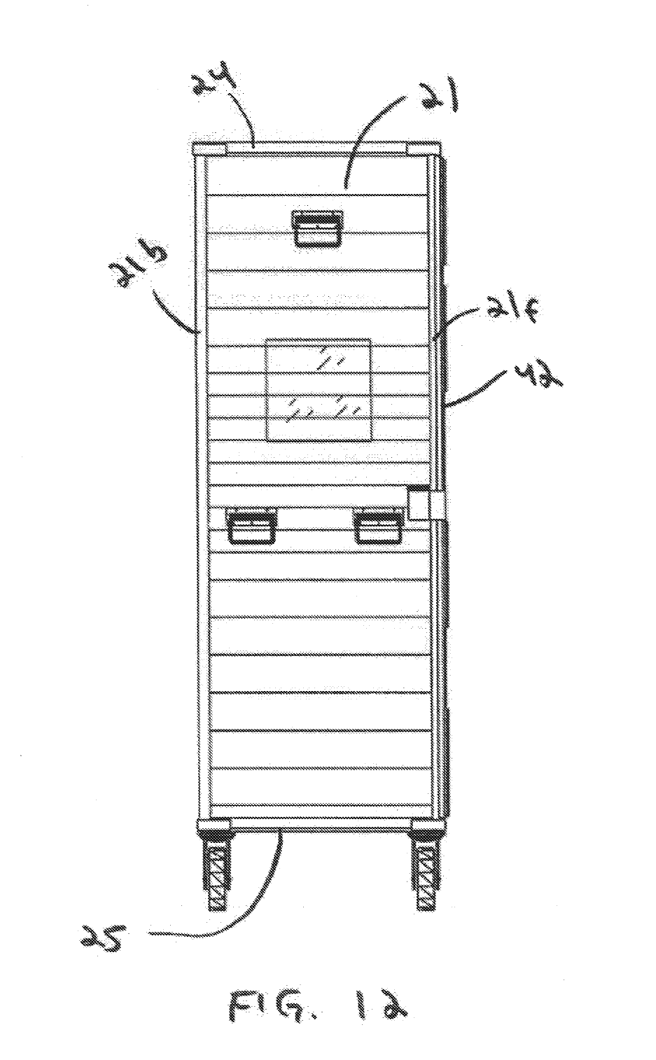

In embodiments including a front lip 21f, the sidewall 21 can also include a back lip 21b. As shown in FIG. 12, a width of the back lip 21b can be substantially equal to the cumulative width of the front lip 21f and the free end 42 of the door 40 in the closed position.

In some embodiments, the bracing member 52, the first engaging member 55, and the second engaging member 53 can be the same length extending from the base 51. In other embodiments, one or more of the bracing member 52, the first engaging member 55, and the second engaging member 53 can have different lengths. For example, the first and second engaging members 55, 56 can have a greater length than the bracing member 52, or the bracing member 52 can have a greater length than the engaging members 55, 56.

The latch 50 in the latched position can be substantially flush with the door 40, the sidewall 21, or both, as shown in FIGS. 11 and 12. With respect to the sidewall 21, the latch 50 in the latched position can be substantially flush with the sidewall lips 21f, 21b. For example, the latch 50 can extend past the outer face of the door 40 and/or the outer side of the sidewall 21 by about 1 inch or less, about ½ inch or less, about ¼ inch or less, or about ⅛ inch or less. In other examples, the latch 50 in the latched position does not extend past the sidewall lips 21f, 21b.

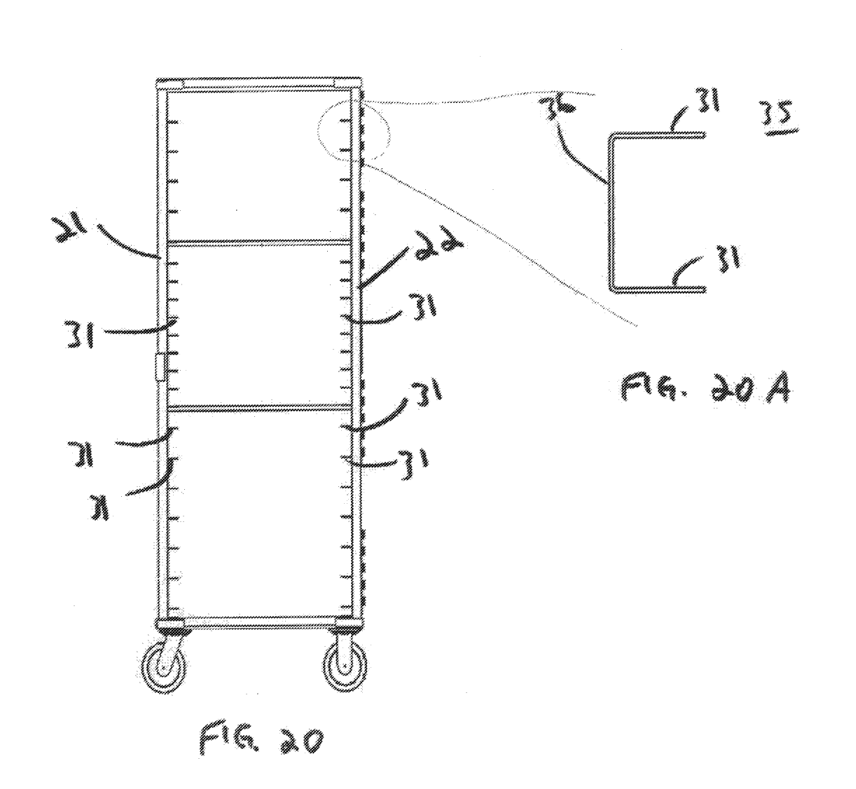

The storage and transport cart 10 can be configured to carry food products, such as bakery goods. In some embodiments as shown in FIG. 20, the interior compartment 30 includes a plurality of horizontal supports 31 for receiving one or more trays in the compartment 30. The horizontal supports 31 can be attached to an inner face of the first sidewall 21 and the second sidewall 22, allowing a plurality of trays to be removably inserted and supported in the cart 10. The supports 31 can spaced apart longitudinally on the sidewalls 21, 22 to accommodate common sizes of products. The interior compartment 30 can be divided into sections, e.g. upper, middle and lower sections, and different sections can have different spacings to accommodate more than one type of product. For example, the supports 31 can be spaced apart by a first distance in a first section and a second distance different from the first distance in a second section. Spacing can be selected from the distances 3 9/15 inches apart and 2⅛ inches apart. In some embodiments, horizontal supports 31 can be formed with substantially C-shaped inserts 35 attached to an inner face of the sidewalls 21, 22. As shown in FIG. 20A, the insert 35 can include a back 36 and two spaced apart supports 31, 31. The back 36 of the insert 35 can be mounted to the sidewalls 21, 22.

The storage and transport cart 10 can also include a plurality of wheels 70 attached to the bottom or another lower portion of the cart 10. The plurality of wheels 70 can include two wheels, three wheels, four wheels or more to facilitate moving the cart 10. The wheels 70 can be attached to the holding body 15 with casters or other suitable attachments.

The storage and transport cart 10 can also include a plurality of handles 80 attached to the holding body 15. In some embodiments, the handles 80 can include a circular, square, or rectangular shape. In some embodiments as shown in FIG. 1, the plurality of handles 80 includes two laterally spaced apart lower handles 81, 82 and one upper handle 83. The lower handles 81, 82 can be disposed on a middle portion or a lower portion of a sidewall 21, 22 and can facilitate lateral movement of the cart 10, such as by pushing or puffing. In some embodiments, the upper handle 83 can be disposed on an upper portion of a sidewall above and between the lower handles 81, 82. The upper handle 83 can facilitate tilting of the cart 10 or other maneuvering during loading/unloading from a container or vehicle.

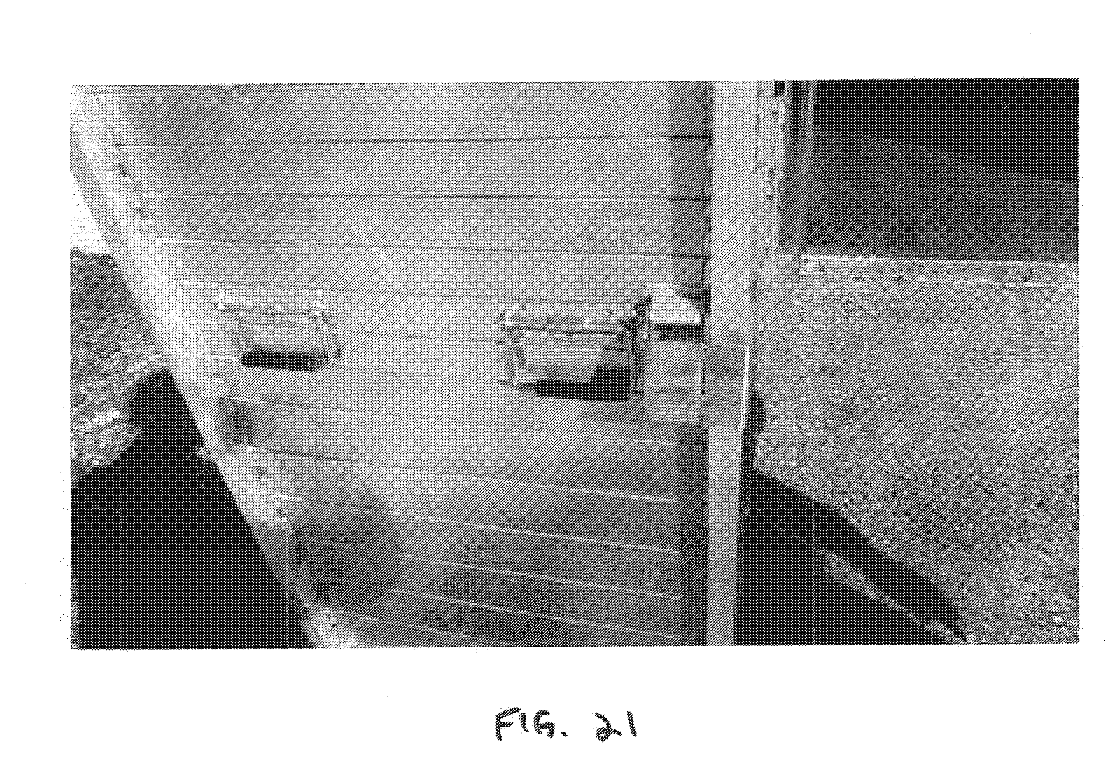

As shown in FIG. 21, the handles 80 can also be substantially flush with the sidewall 21, 22 to which it is attached. For example, each handle can be pivotably attached to the sidewall (e.g. the first sidewall 21) and, in a resting position, rest against the sidewall 21. The handle 80 can have a thickness of 1″ or less, ¾″ or less, ⅔″ or less, ½″ or less, or ¼ or less, such that in the resting position the handle 80 would only slightly extend past the sidewall. In embodiments having a sidewall with lips 21f, 21b, the handle 80 in the resting position can rest against the sidewall 21 without extending past the sidewall lips 21f, 21b. For example, the sidewall lips 21f, 21b can form an outer plane of the sidewall 21 or the sidewall lips 21f, 21b together with the handles 80 in the resting position can form the outer plane of the sidewall 21.

The storage and transport cart 10 can also include a viewing panel 90 attached to one of the walls 20 of the holding body 15. As shown in FIGS. 1 and 2, the viewing panel 90 can be a relatively clear plate for removable insertion of a label to identify the products stored within a cart 10. The plate 90 can include a plastic, an acrylic plastic, or similar material in a thickness of about 1/16 to ⅛ inch. The plate 90 can be attached to a wall 20 with washers and rivets, adhesives, or other suitable fasteners. In one example, the washers can be zinc plated and the rivets can be aluminum. In another example, the washers and rivets can be stainless steel.

The cart 10 and the latch 50 described herein provide numerous advantages in the storage and transport of products and especially fragile or sensitive products such as baked goods. The cart 10 is reinforced in numerous areas to significantly improve durability, while also providing a highly maneuverable and efficient design for loading and unloading from a shipping container or vehicle. Additionally, the unique configuration provides a sleek and efficient ent cart 10 for optimized packing into a cargo container or vehicle and minimizing protrusions that may prevent tighter packing of carts or that may damage adjacently packed carts during transport. The overall size of the carts 10 can also be adapted for specific types of containers. For example, the cart 10 can be sized about 28⅝ to 28 5/16 inches wide along the front and back, about 27⅞ to 28 5/16 inches wide along the sides, and about 72⅞ inches tall for a standard semi-truck trailer.

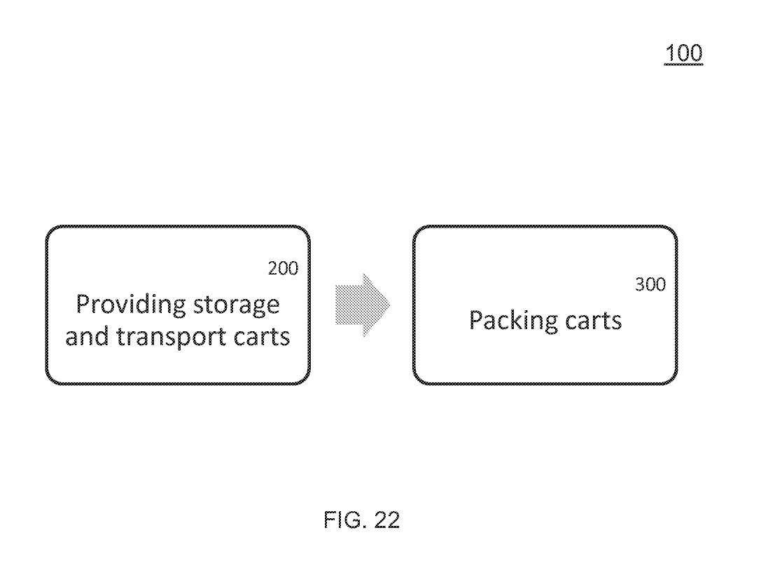

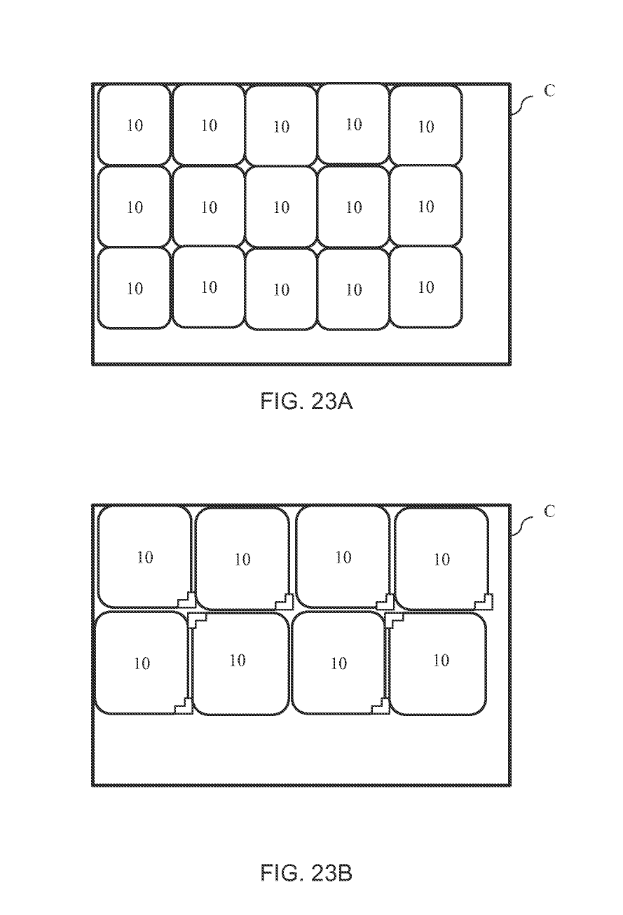

As shown in FIG. 22, a method 100 of transporting products can include providing a plurality of storage and transport carts as described herein at step 200 and packing the carts in a container or a transport vehicle at step 300. The carts can be packed such that the outer sides of the carts fitted against each other. For example, once packed, an outer side of a first cart can be substantially flush against an outer side of a second cart, and so on, minimizing free space between carts. In some arrangements such as shown in FIGS. 23A and 23B, each of the plurality of storage and transport carts, once packed, has an outer side of the cart substantially flush against one or more of the other carts.

The packing step 200 can further include substantially filling a width of the container or storage area of the transport vehicle with the plurality of carts, substantially filling a length of the container or storage area of the transport vehicle with the plurality of carts, or both. As used herein, “substantially filling” a length or width has its plain meaning and includes filling at least a majority of the respective space. In some arrangements, substantially filling can include positioning a plurality of carts side by side such that the remaining interior space along the length and/or width of the container or storage area is less than a width of one of the carts.

In some embodiments, one or more of the storage and transport carts provided at step 200 can include a plurality of handles and wheels attached to the holding body as described above and shown in FIGS. 1-21. The packing step 300 can be performed by pulling on an upper handle of the cart to tilt the cart onto one or two of the wheels and pulling or pushing on one, two, or more of the handles to move the cart into position. Any combination of the handles can be used including, one upper handle, one lower handle, an upper and a lower handle, or two lower handles. This method utilizing carts with handles and/or wheels facilitates lateral movement of the carts for packing 200 and/or unloading carts from a container or transport vehicle.

The unique features of the storage and transport cart 10 and method 100 provide for more effective and economical packing and transportation of the carts, allowing the carts to be fitted together within a container, cargo area of a transport vehicle, or similar storage space to minimize free space between the carts 10 and/or between the plurality of carts 10 and the interior wads of the container. This advantageously optimizes the number of carts that can be packed while also reduces the movement of the carts during transport (e.g., jostling while driving) for more secure and intact delivery of the products stored in each cart. The highly maneuverable carts 10 and method 100 further provide for more efficient packing and unloading of carts 100 during transport and/or storage.

The foregoing is provided for purposes of illustrating, explaining, and describing embodiments of this invention. Modifications and adaptations to these embodiments will be apparent to those skilled in the art and may be made without departing from the scope or spirit of this invention.

What is claimed is:

1. A storage and transport cart comprising:
a holding body comprising a plurality of walls forming an interior compartment;
a door attached to the body and moveable between an open position and a closed position; and
a latch attached to the holding body or door and moveable between a latched position and an unlatched position,
wherein the latch comprises:
a base,
a bracing member extending from the base,
a first engaging member extending from the base and spaced apart from the bracing member, and
a second engaging member extending from the base and spaced apart from first engaging member and the bracing member.

2. The storage and transport cart according to claim 1, wherein the latch is attached to the holding body.

3. The storage and transport cart according to claim 1, wherein an end of the latch is pivotably attached to the holding body and the latch rotates between the latched and unlatched positions.

4. The storage and transport cart according to claim 1, wherein an end of the latch is pivotably attached to the holding body and the latch is rotated downward for the latched position and rotated upward for the unlatched position.

5. The storage and transport cart according to claim 1, wherein:
the plurality of was includes a sidewall having an edge for receiving the door in the closed position; and
the latch is fixedly attached to proximate the edge of the sidewall.

6. The storage and transport cart according to claim 1, wherein in the latched position, a distal portion of the first engaging member and a distal end of the second engaging member engage the door to releasable hold the door in the closed position.

7. The storage and transport cart according to claim 1, wherein:
the door comprises an attached end fixed to the holding body and a free end opposite the attached end;
the plurality of walls of the holding body includes a sidewall having a lip along a front end of the sidewall;
in the closed position, the door rests against an outer side of the sidewall lip; and
in the latched position, the first engaging member engages an inner side of the lip and the second engaging member engages an outer face of the door proximate the free end.

8. The storage and transport cart according to claim 7, wherein the sidewall further comprises a second lip sidewall along a back end of the sidewall and a width of the second lip is substantially equal to a cumulative width of the front end lip and the free end of the door.

9. The storage and transport cart according to claim 1, wherein the latch is substantially flush with the door, a sidewall of the holding body, or both in the latched position.

10. The storage and transport cart according to claim 1, wherein the plurality of walls of the holding body comprises a bottom wall having a drain hole there through.

11. The storage and transport cart according to claim 1, wherein the plurality of walls of the holding body comprises at least one sidewall having a plurality of handles for maneuvering the cart.

12. The storage and transport cart according to claim 11, wherein the plurality of handles includes two laterally spaced apart lower handles and one upper handle.

13. The storage and transport cart according to claim 1, wherein:
the plurality of was of the holding body comprises a first sidewall, a second sidewall opposite the first sidewall, and a back wall extending from a back end of the first sidewall to a back end of the second sidewall; and
the holding body further comprises at least two reinforcing bars extending from the first sidewall to the second sidewall proximate a front end of each.

14. The storage and transport cart according to claim 1, wherein the holding body further comprises a plurality of horizontal supports for receiving one or more trays in the interior compartment.

15. The storage and transport cart according to claim 14, wherein the horizontal supports are attached to an inner face of a first sidewall and a second sidewall opposite the first sidewall.

16. The storage and transport cart according to claim 14, wherein the horizontal supports comprise a plurality of substantially C-shaped insert attached to an inner face of one or more sidewalls of the holding body.

17. A latch for a holding body comprising:
a base;
a bracing member extending from the base;
a first engaging member extending from the base and spaced apart from the bracing member; and
a second engaging member extending from the base and spaced apart from first engaging member and the bracing member.

18. The latch according to claim 17, wherein the bracing member extends from the base at a length less than a length of the second engaging member.

19. A method of transporting products comprising:
providing a plurality of storage and transport carts, each comprising:
a holding body having a plurality of walls forming an interior compartment,
a door attached to the body and moveable between an open position and a closed position, and
a latch attached to the holding body or door and moveable between a latched position and an unlatched position,
wherein the latch comprises:
a base,
a bracing member extending from the base,
a first engaging member extending from the base and spaced apart from the bracing member, and
a second engaging member extending from the base and spaced apart from first engaging member and the bracing member; and
packing the plurality of storage and transport carts in a container of a transport vehicle, wherein outer sides of the carts are fitted against each other.

20. The method according to claim 19, wherein the packing step results in an outer side of a first cart being substantially flush against an outer side of a second cart.
